(19) United States
(12) Patent Application Publication
(10) Pub. No.: US 2026/0031864 A1
(43) Pub. Date: Jan. 29, 2026

(54) METHOD FOR DETERMINING PRECODING MATRIX FOR UPLINK MIMO TRANSMISSION, AND APPARATUS FOR SAME

(71) Applicant: Beijing Xiaomi Mobile Software Co., Ltd., Beijing (CN)

(72) Inventors: Zhenyu ZHANG, Beijing (CN); Xueyuan GAO, Beijing (CN)

(73) Assignee: Beijing Xiaomi Mobile Software Co., Ltd., Beijing (CN)

(21) Appl. No.: 18/998,919

(22) PCT Filed: Aug. 4, 2022
(86) PCT No.: PCT/CN2022/110386

§ 371 Date: Jan. 27, 2025

(51) Int. Cl. H04B 7/0456; H04B 7/06

(52) U.S. Cl. CPC H04B 7/0456; H04B 7/06966

(57) ABSTRACT

A method for determining a precoding matrix for uplink MIMO transmission is provided. The method includes: determining a codebook coefficient used for constructing an 8-antenna port codebook by using a 4-antenna port codebook and/or a 2-antenna port codebook; according to the codebook coefficient, determining a first precoding matrix required for uplink transmission of a terminal device; and pre-encoding data according to the first precoding matrix, and sending pre-encoded data to a network device.

### CROSS-REFERENCE TO RELATED APPLICATIONS

The present application is the U.S. National Stage of International Application No. PCT/CN2022/110386, filed on Aug. 4, 2022, the content of which is incorporated herein by reference in its entirety for all purposes.

### TECHNICAL FIELD

The present disclosure relates to the field of communication technology, in particular, to a method for determining a precoding matrix for uplink MIMO (Multiple Input Multiple Output) transmission, and an apparatus for the same.

### BACKGROUND

The precoding technology in MIMO systems can effectively reduce interference and system overhead, improve system capacity, and is an extremely important key technology in MIMO systems. In MIMO systems based on codebook transmission, the codebook design is also an important part of the precoding technology. The maximum number of antenna ports supported by the codeword in existing uplink MIMO transmission is 4.

### SUMMARY

In the first aspect, the present disclosure provides a method for determining a precoding matrix for uplink MIMO transmission, which includes: determining a codebook coefficient used for constructing an 8-antenna port codebook from a 4-antenna port codebook and/or a 2-antenna port codebook; determining, based on the codebook coefficient, a first precoding matrix required for uplink transmission of the terminal device; and pre-encoding data based on the first precoding matrix and sending the data to a network device.

In the second aspect, the present disclosure provides a method for determining a precoding matrix for uplink MIMO transmission, which includes: sending a TPMI to a terminal device, wherein the TPMI is configured to determine a first precoding matrix in an 8-antenna port codebook, and the first precoding is a precoding matrix required for uplink transmission of the terminal device; and receiving data pre-encoded based on the first precoding matrix and sent by the terminal device.

In the third aspect, the present disclosure provides a communication device including a processor, and when the processor executes a computer program in a memory, the method described in the first aspect is caused to be performed.

In the fourth aspect, the present disclosure provides a communication device including a processor, and when the processor executes a computer program in a memory, the method described in the second aspect is caused to be performed.

In the fifth aspect, the present disclosure provides a communication device including a processor and a memory for storing a computer program, wherein the processor is configured to execute the computer program stored in the memory to cause the method described in the first aspect to be performed.

In the sixth aspect, the present disclosure provides a communication device including a processor and a memory for storing a computer program, wherein the processor is configured to execute the computer program stored in the memory to cause the method described in the second aspect to be performed.

In the seventh aspect, the present disclosure provides a communication device including a processor and an interface circuit, wherein the interface circuit is configured to receive and transmit code instructions to the processor, and the processor is configured to run the code instructions to cause the method described in the first aspect to be performed.

In the eighth aspect, the present disclosures provide a communication device including a processor and an interface circuit, wherein the interface circuit is configured to receive and transmit code instructions to the processor, and the processor is configured to run the code instructions to cause the method described in the second aspect to be performed.

In the ninth aspect, the present disclosure provides a computer-readable storage medium for storing instructions used for the terminal device, which when executed cause the terminal device to perform the method described in the first aspect.

In the tenth aspect, the present disclosure provides a computer-readable storage medium for storing instructions used for the network device, which when executed cause the network device to perform the method described in the second aspect.

In the eleventh aspect, the present disclosure provides a computer program product including a computer program. The computer program, when running on a computer, causes the computer to implement the method described in the first aspect.

In the twelfth aspect, the present disclosure provides a computer program product including a computer program. The computer program, when running on a computer, causes the computer to implement the method described in the second aspect.

In the thirteenth aspect, the present disclosure provides a chip system including at least one processor and an interface for supporting a terminal device in achieving the functions related to the first aspect, such as determining or processing at least one of the data and information involved in the above method. In some embodiments, the chip system further includes a memory for storing necessary computer programs and data for the terminal device. The chip system can be composed of chips or include chips and other discrete devices.

In the fourteenth aspect, the present disclosure provides a chip system including at least one processor and an interface for supporting a network device in achieving the functions related to the second aspect, such as determining or processing at least one of the data and information involved in the above method. In some embodiments, the chip system further includes memory for storing necessary computer programs and data for the network device. The chip system can be composed of chips or include chips and other discrete devices.

In the fifteen aspect, the present disclosure provides a computer program, which when is running on a computer, causes the computer to implement the method described in the first aspect.

In the sixteenth aspect, the present disclosure provides a computer program, which when is running on a computer, causes the computer to implement the method described in the second aspect.

### BRIEF DESCRIPTION OF THE DRAWINGS

In order to more clearly illustrate the technical solutions in the embodiments or background technology of the present disclosure, the accompanying drawings required for use in the embodiments or background technology of the present disclosure will be described below.

FIG. 1 is a schematic diagram of an architecture of a communication system according to embodiments of the present disclosure;

FIG. 2 is a schematic flowchart of a method for determining a precoding matrix for uplink MIMO transmission according to embodiments of the present disclosure;

FIG. 3 is a schematic flowchart of a method for determining a precoding matrix for uplink MIMO transmission according to embodiments of the present disclosure;

FIG. 4 is a schematic flowchart of a method for determining a precoding matrix for uplink MIMO transmission according to embodiments of the present disclosure;

FIG. 5 is a schematic flowchart of a method for determining a precoding matrix for uplink MIMO transmission according to embodiments of the present disclosure;

FIG. 6 is a schematic flowchart of a method for determining a precoding matrix for uplink MIMO transmission according to embodiments of the present disclosure;

FIG. 7 is a schematic flowchart of a method for determining a precoding matrix for uplink MIMO transmission according to embodiments of the present disclosure;

FIG. 8 is a schematic flowchart of a method for determining a precoding matrix for uplink MIMO transmission according to embodiments of the present disclosure;

FIG. 9 is a schematic flowchart of a method for determining a precoding matrix for uplink MIMO transmission according to embodiments of the present disclosure;

FIG. 10 is a schematic diagram of a structure of a communication apparatus according to embodiments of the present disclosure;

FIG. 11 is a schematic diagram of a structure of a communication device according to embodiments of the present disclosure; and

FIG. 12 is a schematic diagram of a structure of a chip according to embodiments of the present disclosure.

### DETAILED DESCRIPTION

A detailed explanation of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

Terms used in present disclosure are for the purpose of describing specific embodiments only and are not intended to limit the present disclosure. The singular forms “a” and “the” used in the present disclosure and the appended claims are also intended to include the multiple forms, unless the context clearly indicates otherwise. It should also be understood that the term “and/or” used herein refers to and includes any or all possible combinations of one or more related items listed.

It should be understood that although various information may be described using terms such as first, second, and third in present disclosure, such information should not be limited to these terms. These terms are only used to distinguish information of the same type from each other. For example, without departing from the scope of the present disclosure, the first information can also be referred to as the second information, and similarly, the second information can also be referred to as the first information. For example, the words “if” and “as if”' used herein can be interpreted as “when”, or “while”, or “in response to determination”, depending on the context. For the purpose of simplicity and ease of understanding, the terms used herein to characterize size relationships include “greater than” or “less than”, or “higher than” or “lower than”. For those skilled in the art, it can be understood that the term “greater than” also encompasses the meaning of “greater than or equal to”, the term “less than” also encompasses the meaning of “less than or equal to”, the term “higher than” also encompasses the meaning of “'higher than or equal to”, and the term “lower than” also encompasses the meaning of “lower than or equal to”.

For ease of understanding, terms involved in the present disclosure are first introduced.

Physical Uplink Shared Channel (PUSCH), the PUSCH is used to carry data from the transmission channel USCH.

Coherent transmission is defined as a capability of UE. The coherent transmission capability of UE includes full-coherent transmission, partial-coherent transmission, and non-coherent transmission.

Full-coherent transmission, all antenna ports can transmit coherently.

Partial-coherent transmission, antenna ports within the same coherent transmission group can transmit coherently, and antenna ports within different coherent transmission groups cannot transmit coherently. Each coherent transmission group includes at least two antenna ports.

Non-coherent transmission, no antenna ports can transmit coherently.

The maximum number of antenna ports supported by the codeword in existing uplink MIMO transmission is 4. With the enhancement of transmission demands and transmission scenarios, the uplink transmission can support increased numbers of antenna ports and uplink transmission layers. The number of antenna ports can be increased from 4 to a maximum of 8 antenna ports, and correspondingly, the number of uplink transmission layers can be changed from 4 to L, where the value of L can be, for example, 1 to 8. However, the number of codewords in the codebook will significantly increase as the numbers of antenna ports and transmission layers increase, resulting in greater TPMI overhead. Therefore, when the 8-port transmission is supported in the uplink MIMO systems, it is necessary to design corresponding precoding matrix selection and indication schemes to meet the requirements for the MIMO uplink enhancement.

According to the method for determining the precoding matrix for the uplink MIMO transmission provided in embodiments of the present disclosure, the full-coherent transmission codewords applicable to antennas in the communication systems can be determined. The communication system to which following first describes the applicable to the embodiments of the present disclosure.

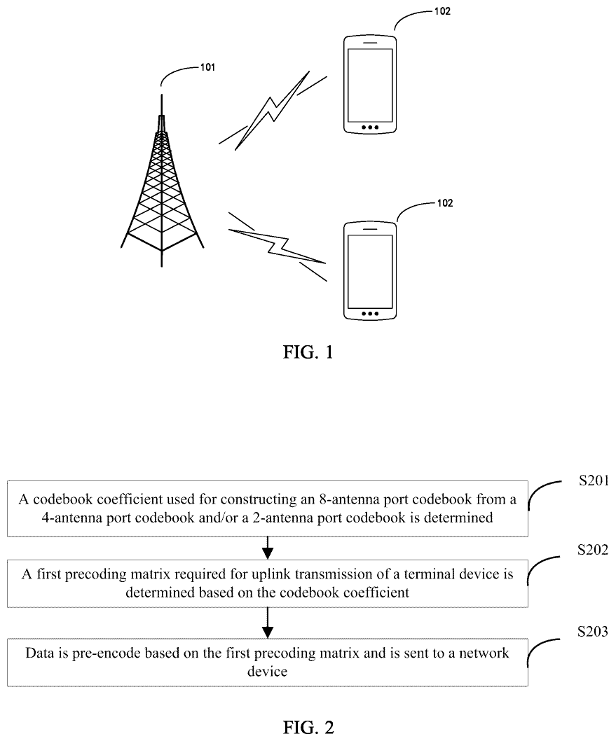

Reference is made to FIG. 1, a schematic diagram of an architecture of a communication system according to embodiments of the present disclosure is provided. The communication system can include, but is not limited to, a network device and a terminal device. The number and forms of devices shown in FIG. 1 are for example only and do not constitute a limitation on embodiments of the present disclosure. In practical applications, two or more network devices and two or more terminal devices can be included. The communication system shown in FIG. 1 takes that a network device 101 and a terminal device 102 are included as an example.

It should be noted that technical solutions provided in embodiments of the present disclosure can be applied to various communication systems, such as the Long Term Evolution (LTE) system, the 5th generation (5G) mobile communication system, the 5G New Radio (NR) system, or other new mobile communication systems in the future. It should also be noted that a sidelink in embodiments of the present disclosure can also be referred to as a side link or a direct link.

The network device 101 in embodiments of the present disclosure is an entity on the network side for transmitting or receiving signals. For example, the network device 101 can be an evolved NodeB (eNB), a transmission reception point (TRP), a next generation NodeB (gNB) in the NR system, a base station in other future mobile communication systems, or an access point in wireless fidelity (WiFi) systems, etc. Embodiments of the present disclosure do not limit the specific technology and device form adopted by the network device. The network device provided in embodiments of the present disclosure can include a central unit (CU) and a distributed unit (DU). The CU can also be referred to as a control unit. The CU-DU structure can separate the protocol layer of the network device, for example, the base station, with some protocol layer functions being placed in the CU under centralized control, and the remaining or all protocol layer functions being distributed in the DU, where DU is centrally controlled by CU.

The terminal device 102 in embodiments of the present disclosure is an entity on the user side for receiving or transmitting signals, such as a mobile phone. The terminal device can also be referred to as the terminal, the user equipment (UE), the mobile station (MS), the mobile terminal (MT), etc. The terminal device can include devices having communication capabilities, such as cars, smart cars, mobile phones, wearable devices, and Pads, or devices having wireless transmission and reception capabilities, such as computers, virtual reality (VR) terminals, augmented reality (AR) terminals, wireless terminals in industrial control, wireless terminals in self-driving, wireless terminals in remote medical surgery, wireless terminals in smart grid, wireless terminals in transportation safety, wireless terminals in smart city, and wireless terminals in smart home. Embodiments of the present disclosure do not limit the specific technology and device form adopted by the terminal device.

There are four types of sidelink transmission modes in the sidelink communication. A sidelink transmission mode 1 and a sidelink transmission mode 2 are used for Device To Device (D2D) communication between terminal devices. A sidelink transmission mode 3 and a sidelink transmission mode 4 are used for V2X (Vehicle to Everything) communication. When the sidelink transmission mode 3 is used, the resource allocation is scheduled by the network device 101. In some embodiments, the network device 101 can send resource allocation information to the terminal device 102, and the terminal device 102 then allocates resources to another terminal device, so that the other terminal device can send information to the network device 101 through the allocated resources. In the V2X communication, the terminal device with good signal quality or high reliability can be used as the terminal device 102. A first terminal device mentioned in embodiments of the present disclosure can refer to the terminal device 102, and a second terminal device can refer to that the other terminal device.

It can be understood that the communication system described in embodiments of the present disclosure is for the purpose of making a clearer explanation of the technical solutions provided in embodiments of the present disclosure, which does not constitute a limitation on the technical solutions provided in the embodiments of the present disclosure. Those of ordinary skill in the art know that with the evolution of system architectures and the emergence of new business scenarios, the technical solutions provided in the embodiments of the present disclosure are also applicable to similar technical problems.

It should be noted that the method for determining the precoding matrix for the uplink MIMO transmission provided in any embodiment of the present disclosure can be performed separately, or combined with possible implementations in other embodiments, or can be performed together with any technical solution in the related art.

The method and apparatus for determining the precoding matrix for the uplink MIMO transmission provided in the present disclosure will be described in detail in the following with reference to the drawings.

Reference is made to FIG. 2, a flowchart of a method for determining a precoding matrix for uplink MIMO transmission according to embodiments of the present disclosure is provided. The method for determining the precoding matrix for the uplink MIMO transmission is performed by a terminal device. As shown in FIG. 2, the method can include but is not limited to the following steps.

In step S201, a codebook coefficient used for constructing an 8-antenna port codebook from a 4-antenna port codebook and/or a 2-antenna port codebook is determined.

In some embodiments, in the case of a single-antenna panel, the codebook coefficient includes a co-phase coefficient.

In some embodiments, in the case of a multi-antenna panel, the codebook coefficient includes a co-phase coefficient, and a compensation factor for the antenna panel.

The 8-antenna port codebook can be obtained by splicing low dimensional 4-antenna port codebook and/or 2-antenna port codebook. In the process of splicing the 4-antenna port codebook and/or 2-antenna port codebook, it is necessary to determine the codebook coefficient, to splice candidate codewords in the 4-antenna port codebook and/or 2-antenna port codebook based on the codebook coefficient, to generate the 8-antenna port codebook. For example, a possible implementation of 8-antenna port codewords is

$${W}_{8 Tx} = [ \begin{matrix}{W}_{4 Tx} & {W}_{4 Tx} \\ φ {W}_{4 Tx} & - φ {W}_{4 Tx}\end{matrix} ] ,$$

which is obtained by splicing 4-antenna port codewords and by introducing a co-phase coefficient.

It should be noted that the co-phase coefficients corresponding to different antenna structures are different. In some embodiments, when a phase angle interval between antennas is 90°, the co-phase coefficient can be one of 1, −1, j, and −j, that is φ=+1, −1, +j, −j. In some embodiments, when a phase angle interval between antennas is 45°, the co-phase coefficient can be one of 1,

$$\frac{\sqrt{2}}{2} ( 1 + j ) , j , \frac{\sqrt{2}}{2} ( - 1 + j ) , - 1 , \frac{\sqrt{2}}{2} ( - 1 - j ) , - j , and \frac{\sqrt{2}}{2} ( 1 - j ) .$$

In step S202, a first precoding matrix required for uplink transmission of a terminal device is determined based on the codebook coefficient.

In some embodiments, in the case where the 8-antenna port codebook has been constructed, the terminal device can report the codebook coefficient, and the network device determines the first precoding matrix from the 8-antenna port codebook based on the codebook coefficient. The first precoding matrix is then indicated to the terminal device. Correspondingly, the terminal device can receive the first precoding matrix indicated by the network device.

In some embodiments, in the case where the 8-antenna port codebook has not been constructed from the 4-antenna port codebook or the 2-antenna port codebook, the terminal device can receive a second precoding matrix determined by the network device from the 4-antenna port codebook or the 2-antenna port codebook, and then the terminal device obtains the first precoding matrix corresponding to the 8-antenna port codebook through splicing based on the codebook coefficient and the second precoding matrix.

In some embodiments, the network device sends a Transmit Precoding Matrix Indicator (TPMI) to the terminal device. The TPMI is configured to indicate an optimal precoding matrix determined by the network device based on channel estimation. In some embodiments, the optimal precoding matrix can be the first precoding matrix determined from the 8-antenna port codebook, or the optimal precoding matrix can be the second precoding matrix determined from the 4-antenna port codebook or the 2-antenna port codebook.

In some embodiments, in the case where the network device directly indicates the first precoding matrix through the TPMI, the terminal device can determine, based on the TPMI, the corresponding first precoding matrix for the uplink transmission from the 8-antenna port codebook corresponding to the uplink MIMO transmission. In some embodiments, a mapping relationship between the TPMIs and the precoding matrixes in the 8-antenna port codebook can be pre-set. The terminal device can determine, based on the received TPMI, the first precoding matrix for the uplink transmission from the 8-antenna port codebook.

In some embodiments, in the case where the terminal device determines the first precoding matrix based on the codebook coefficient and the second precoding matrix, the terminal device can determine, based on the TPMI, the corresponding second precoding matrix for the uplink transmission from the 4-antenna port codebook or the 2-antenna port codebook corresponding to the uplink MIMO transmission. In some embodiments, a mapping relationship between TPMI indexes and the precoding matrixes in the 4-antenna port codebook or in the 2-antenna port codebook can be pre-set. The terminal device can determine, based on the received TPMI, the second precoding matrix required for the uplink transmission from the 4-antenna port codebook or the 2-antenna port codebook.

In step S203, data is pre-encode based on the first precoding matrix and is sent to a network device.

After the first precoding matrix is obtained, the data to be transmitted can be pre-encoded based on the first precoding matrix, and the pre-encoded data can be sent to the network device. The data to be transmitted can be PUSCH, which means that the terminal device pre-encodes the PUSCH through the first precoding matrix and sends the pre-encoded PUSCH to the network device.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

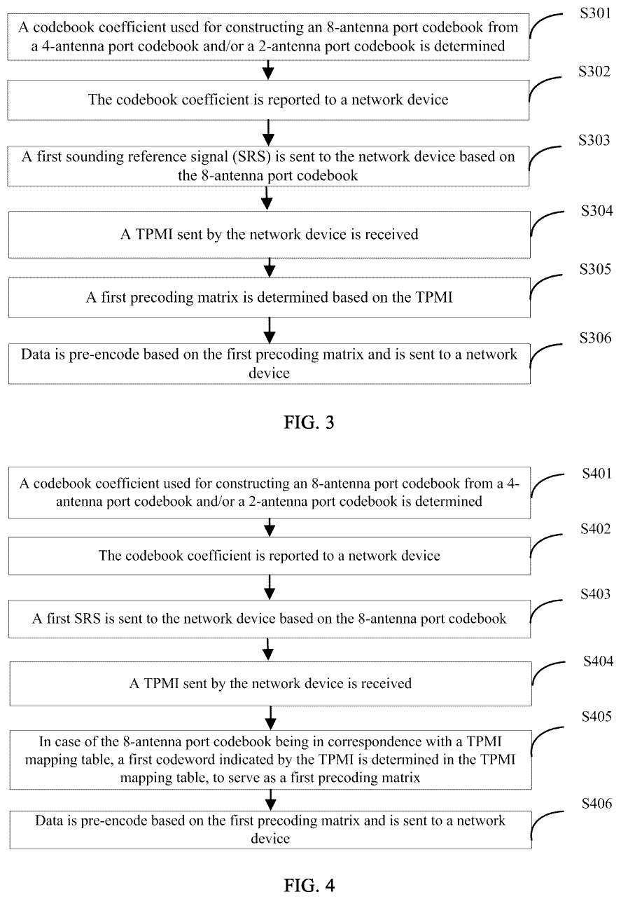

Reference is made to FIG. 3, a flowchart of a method for determining a precoding matrix for uplink MIMO transmission according to embodiments of the present disclosure is provided. The method for determining the precoding matrix for the uplink MIMO transmission is performed by a terminal device. As shown in FIG. 3, the method can include but is not limited to the following steps.

In step S301, a codebook coefficient used for constructing an 8-antenna port codebook from a 4-antenna port codebook and/or a 2-antenna port codebook is determined.

In some embodiments, the codebook coefficient includes a co-phase coefficient and/or a compensation factor for the antenna panel.

In some embodiments, the co-phase coefficients corresponding to different antenna structures are different.

In some embodiments, when a phase angle interval between antennas is 90°, the co-phase coefficient can be one of 1, −1, j, and −j, that is φ=+1, −1, +j, −j.

In some embodiments, when a phase angle interval between antennas is 45°, the co-phase coefficient can be one of 1,

$$\frac{\sqrt{2}}{2} ( 1 + j ) , j , \frac{\sqrt{2}}{2} ( - 1 + j ) , - 1 , \frac{\sqrt{2}}{2} ( - 1 - j ) , - j , and \frac{\sqrt{2}}{2} ( 1 - j ) .$$

In step S302, the codebook coefficient is reported to a network device.

In some embodiments, a codebook coefficient index is reported to the network device based on the antenna structure information. The codebook coefficient index is used to indicate the codebook coefficient, and the codebook coefficient is at least one coefficient in a candidate codebook coefficient set.

Different phase angle intervals between antennas correspond to different numbers of codebook coefficients included in the candidate codebook coefficient set. In some embodiments of the present disclosure, the number of bits occupied by the codebook coefficient index is determined based on the phase angle interval between antennas in the antenna structure information, and the codebook coefficient index is reported to the network device based on the number of bits occupied.

In some embodiments of the present disclosure, the correspondence between the codebook coefficient and the codebook coefficient index is constructed in advance. The terminal device can report the codebook coefficient to the network device based on the correspondence. The network device can determine the codebook coefficient reported by the terminal device by querying the correspondence based on the received codebook coefficient index.

In some embodiments, when the phase angle interval between antennas is 90°, the correspondence between the co-phase coefficient and the coefficient index is shown in Table 1.

TABLE 1

| Codebook | | | | |
|---|---|---|---|---|
| coefficient index | 0 | 1 | 2 | 3 |
| Phase angle interval | 0° | 90° | 180° | 270° |
| Co-phase coefficient | +1 | +j | −1 | −j |

In some embodiments, when the phase angle interval between antennas is 45°, the correspondence between the co-phase coefficient and the coefficient index is shown in Table 2.

TABLE 2

| Codebook | | | | | | | | |
|---|---|---|---|---|---|---|---|---|
| coefficient | | | | | | | | |
| index | 0 | 1 | 2 | 3 | 4 | 5 | 6 | 7 |
| Phase angle | 0° | 45° | 90° | 135° | 180° | 225° | 270° | 315° |
| interval | | | | | | | | |
| Co-phase coefficient | +1 | $\frac{\sqrt{2}}{2} ( 1 + j )$ | +j | $\frac{\sqrt{2}}{2} ( - 1 + j )$ | −1 | $\frac{\sqrt{2}}{2} ( - 1 - j )$ | −j | $\frac{\sqrt{2}}{2} ( 1 - j )$ |

It can be understood that each element in Table 1 and Table 2 exists independently, and these elements are listed in the same table as an example, but it does not mean that all elements in the table must exist simultaneously as shown in the table. The value of each element is independent of values of any other elements in Table 1 and Table 2. Those skilled in the art can understand that the value of each element in Table 1 and Table 2 is an independent embodiment.

As shown in Table 1, when the phase angle interval between antennas is 90°, the candidate codebook coefficient set includes 4 codebook coefficients, and the terminal device can determine that the number of bits occupied by the codebook coefficient index is 2 bits. That is, the terminal device needs to occupy 2 bits to indicate the codebook coefficient index to the network device. As shown in Table 2, when the phase angle interval between antennas is 45°, the candidate codebook coefficient set includes 8 codebook coefficients, and the terminal device can determine that the number of bits occupied by the codebook coefficient index is 3 bits. That is, the terminal device needs to occupy 3 bits to indicate the codebook coefficient index to the network device.

In step S303, a first sounding reference signal (SRS) is sent to the network device based on the 8-antenna port codebook.

In codebook based PUSCH transmission in the uplink MIMO, the terminal device needs to obtain the optimal precoding matrix. In some embodiments of the present disclosure, the terminal device can send, based on the 8-antenna port codebook, the first SRS for the 8-antenna port to the network device. The network device can estimate the uplink channel based on the first SRS sent by the terminal device, and determine the optimal codewords for the uplink transmission from the 8-antenna port codebook as the first precoding matrix. In some embodiments, the network device can indicate the TPMI corresponding to the first precoding matrix to the terminal device.

In some embodiments, the network device can further determine, based on uplink channel estimation, the corresponding SRS resources, transmission layers, and modulation and coding schemes (MCS) for the uplink transmission.

In step S304, a TPMI sent by the network device is received.

In some embodiments, the TPMI is used to indicate the first precoding matrix, and the first precoding matrix is the optimal codeword determined from the 8-antenna port codebook based on the codebook coefficient and the first SRS.

In some embodiments, the terminal device can further receive information such as SRS resources, transmission layers, and the MCS indicated by the network device.

In step S305, a first precoding matrix is determined based on the TPMI.

The terminal device can determine, based on the TPMI, the first precoding matrix corresponding to the uplink transmission from the 8-antenna port codebook. In some embodiments, the terminal device can further determine, based on the indication by the network device, the transmission layers and the MCS corresponding to the uplink transmission.

In step S306, data is pre-encode based on the first precoding matrix and is sent to a network device.

In some embodiments, the terminal device can modulate and encode, according to the MCS indicated by the network device, the data to be transmitted. In some embodiments, the terminal device performs precoding on the data to be transmitted based on the first precoding matrix indicated by the TPMI. In some embodiments, the terminal device sends the encoded data based on the transmission layers corresponding to the uplink transmission and the SRS resources indicated by the SRS resource indicator (SRI). The network device can estimate the uplink channel based on the demodulation reference signal (DMRS) and detect the data sent by the terminal device, to receive the data sent by the terminal device.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

Reference is made to FIG. 4, a flowchart of a method for determining a precoding matrix for uplink MIMO transmission according to embodiments of the present disclosure is provided. The method for determining the precoding matrix for the uplink MIMO transmission is performed by a terminal device. As shown in FIG. 4, the method can include but is not limited to the following steps.

In step S401, a codebook coefficient used for constructing an 8-antenna port codebook from a 4-antenna port codebook and/or a 2-antenna port codebook is determined. In step S402, the codebook coefficient is reported to a network device.

In step S403, a first SRS is sent to the network device based on the 8-antenna port codebook.

In step S404, a TPMI sent by the network device is received.

For the specific explanations of steps S401 to S404, reference can be made to the relevant contents recorded in the above embodiments, which will not be repeated here.

In step S405, in case of the 8-antenna port codebook being in correspondence with a TPMI mapping table, a first codeword indicated by the TPMI is determined in the TPMI mapping table, to serve as a first precoding matrix.

In some embodiments, the TPMI mapping table includes a mapping relationship between candidate TPMI index values and candidate codewords in the 8-antenna port codebook.

In some embodiments, for the co-phase coefficients φ=+1, −1, +j, −j, a set S_{8Tx} including all codewords for the uplink transmission based on 8-antenna ports can constructed. The set S_{8Tx} can include four subsets of codewords, namely S_{8Tx,φ=+1}, S_{8Tx,φ=-1}, S_{8Tx,φ=+j}, and S_{8Tx,φ=-j}. These four subsets of codewords correspond to different co-phase coefficients. That is, the 8-antenna port codebook corresponds to a TPMI mapping table that includes the above four subsets of codewords, and all codewords in the 8-antenna port codebook are indicated using the TPMI mapping table.

After receiving the TPMI sent by the network device, the terminal device can query the TPMI mapping table to obtain a candidate TPMI consistent with the received TPMI, and the candidate codeword indicated by the candidate TPMI consistent with the received TPMI is used as a first codeword, which serves as the first precoding matrix.

In some embodiments, an index in the TPMI mapping table can be indicated through ┌log₂^{card(S}^{_{8Tx}}⁾┐ bits, allowing the network device to send the TPMI to the terminal device through ┌log₂^{card(S}^{_{8Tx}}⁾┐ bits.

In step S406, data is pre-encode based on the first precoding matrix and is sent to a network device.

For the specific explanations of step S406, reference can be made to the relevant contents recorded in the above embodiments, which will not be repeated here.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

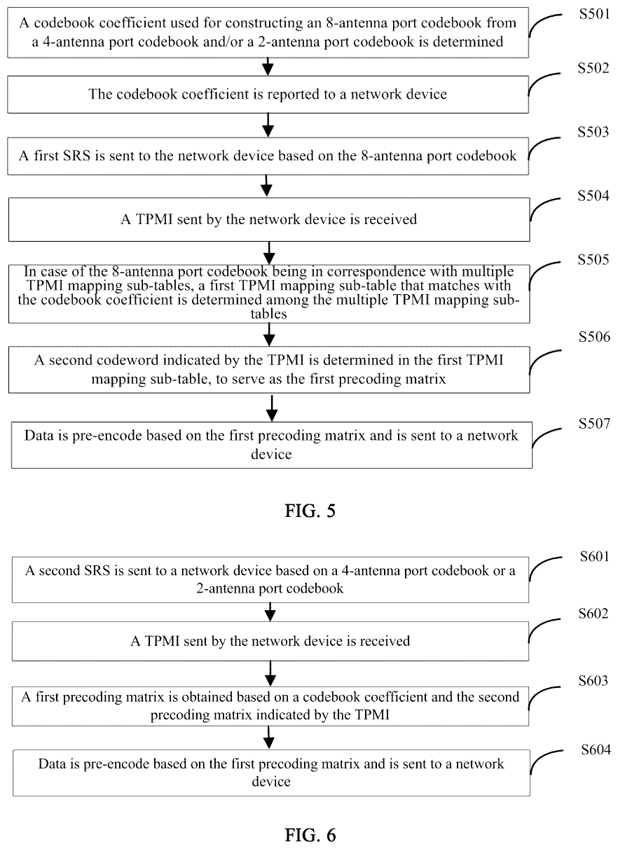

Reference is made to FIG. 5, a flowchart of a method for determining a precoding matrix for uplink MIMO transmission according to embodiments of the present disclosure is provided. The method for determining the precoding matrix for the uplink MIMO transmission is performed by a terminal device. As shown in FIG. 5, the method can include but is not limited to the following steps.

In step S501, a codebook coefficient used for constructing an 8-antenna port codebook from a 4-antenna port codebook and/or a 2-antenna port codebook is determined.

In step S502, the codebook coefficient is reported to a network device.

In step S503, a first SRS is sent to the network device based on the 8-antenna port codebook.

In step S504, a TPMI sent by the network device is received.

For the specific explanations of steps S501 to S504, reference can be made to the relevant contents recorded in the above embodiments, which will not be repeated here.

In step S505, in case of the 8-antenna port codebook being in correspondence with multiple TPMI mapping sub-tables, a first TPMI mapping sub-table that matches with the codebook coefficient is determined among the multiple TPMI mapping sub-tables.

In some embodiments, different codebook coefficients correspond to different mapping sub-tables, and the mapping sub-tables include a mapping relationship between candidate TPMIs and candidate codewords in the 8-antenna port codebook.

In some embodiments, for the co-phase coefficients φ=+1, −1, +j, −j, a set S_{8Tx} including all codewords for the uplink transmission based on 8-antenna ports can constructed. The set S_{8Tx} can include four subsets of codewords, namely S_{8Tx,φ=+1}, S_{8Tx,φ=-1}, S_{8Tx,φ=+j}, and S_{8Tx,φ=-j}. These four subsets of codewords correspond to different co-phase coefficients. That is, the 8-antenna port codebook corresponds to a TPMI mapping table that includes the above four subsets of codewords, and all codewords in the 8-antenna port codebook are indicated using the TPMI mapping table.

In some embodiments of the present disclosure, different TPMI mapping sub-tables can be configured in advance for different subsets of codewords. In some embodiments, for S_{8Tx,φ=+1}, S_{8Tx,φ=-1}, S_{8Tx,φ=+j}, and S_{8Tx,φ=-j}, corresponding TPMI mapping sub-tables can be respectively configured in advance. That is, all codewords in the 8-antenna port codebook are indicated using 4 TPMI mapping sub-tables.

After receiving the TPMI, the terminal device can determine, from the multiple TPMI sub-tables, the first TPMI mapping sub-table corresponding to the co-phase coefficient reported to the network device.

It should be noted that an index in the TPMI mapping sub-table is indicated through ┌log₂^{max(card(S}^{_{8Tx}}^{,φ=x))}┐ bits, allowing the network device to send the TPMI to the terminal device through ┌log₂^{max(card(S}^{_{8Tx}}^{,φ=x))}┐ bits.

In step S506, a second codeword indicated by the TPMI is determined in the first TPMI mapping sub-table, to serve as the first precoding matrix.

The terminal device can query the first TPMI mapping sub-table to obtain a candidate TPMI consistent with the received TPMI, and the candidate codeword indicated by the candidate TPMI in the first TPMI mapping sub-table is used as a second codeword, which serves as the first precoding matrix.

In step S507, data is pre-encode based on the first precoding matrix and is sent to a network device.

For the specific explanations of step S507, reference can be made to the relevant contents recorded in the above embodiments, which will not be repeated here.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

It should be noted that in the case where the 8-antenna port codebook corresponds to a TPMI mapping table, the TPMI is sent by the network device using a first bit number, and in the case where the 8-antenna port codebook corresponds to multiple TPMI mapping sub-tables, the TPMI is sent by the network device using a second bit number. The second bit number is less than or equal to the first bit number. In some embodiments, the number of codewords included in each TPMI mapping sub-table can be a maximum number of codewords determined from the codewords included in the TPMI mapping sub-table, and the second bit number can be determined based on the maximum number of codewords.

Reference is made to FIG. 6, a flowchart of a method for determining a precoding matrix for uplink MIMO transmission according to embodiments of the present disclosure is provided. The method for determining the precoding matrix for the uplink MIMO transmission is performed by a terminal device. As shown in FIG. 6, the method can include but is not limited to the following steps.

In step S601, a second SRS is sent to a network device based on a 4-antenna port codebook or a 2-antenna port codebook.

In step S602, a TPMI sent by the network device is received.

In some embodiments, the TPMI is used to indicate the second precoding matrix, and the second precoding matrix is the optimal codeword determined from the 4-antenna port codebook or the 2-antenna port codebook based on the second SRS.

In step S603, a first precoding matrix is obtained based on a codebook coefficient and the second precoding matrix indicated by the TPMI.

The terminal device selects, based on the TPMI, the corresponding second precoding matrix from the set S_{2Tx} of codewords or the set S_{4Tx} of codewords, and splices the second precoding matrix based on the co-phase coefficient φ=x and a splicing formula for the 8-antenna port codewords, to generate the 8-antenna port codeword, thereby avoiding too large of the set of 8-port codewords and the corresponding TPMI bit overhead.

In some embodiments, the method for splicing the codewords can be

$${W}_{8 Tx} = [ \begin{matrix}{W}_{4 Tx} & {W}_{4 Tx} \\ φ {W}_{4 Tx} & - φ {W}_{4 Tx}\end{matrix} ] ,$$

which is obtained by splicing 4-antenna port codewords and by introducing the co-phase coefficient.

In step S604, data is pre-encode based on the first precoding matrix and is sent to a network device.

For the specific explanations of step S604, reference can be made to the relevant contents recorded in the above embodiments, which will not be repeated here.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

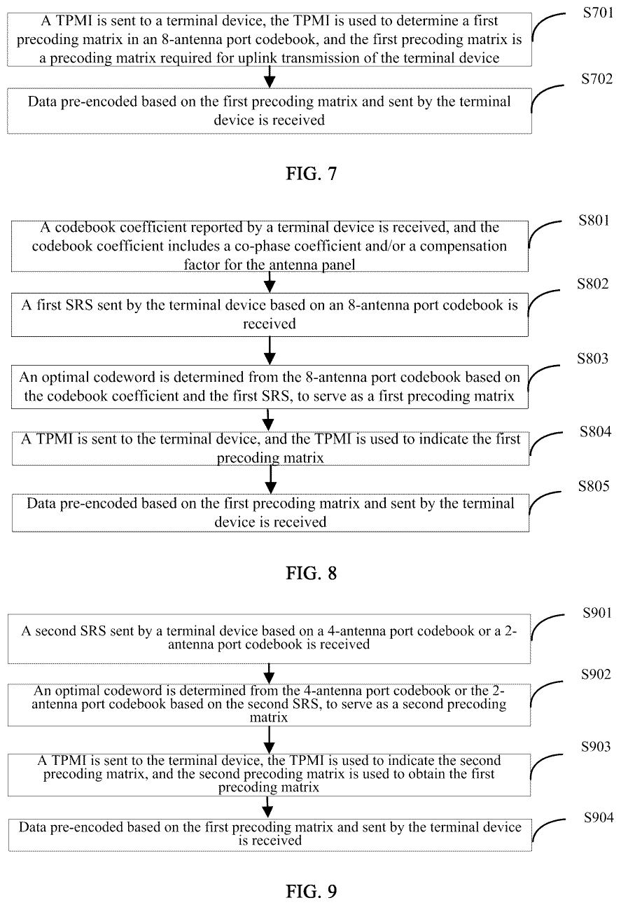

Reference is made to FIG. 7, a flowchart of a method for determining a precoding matrix for uplink MIMO transmission according to embodiments of the present disclosure is provided. The method for determining the precoding matrix for the uplink MIMO transmission is performed by a network device. As shown in FIG. 7, the method can include but is not limited to the following steps.

In step S701, a TPMI is sent to a terminal device. The TPMI is used to determine a first precoding matrix in an 8-antenna port codebook, and the first precoding matrix is a precoding matrix required for uplink transmission of the terminal device.

In some embodiments, in the case where the 8-antenna port codebook has been constructed, the terminal device can report the codebook coefficient, and the network device further determines the first precoding matrix from the 8-antenna port codebook based on the codebook coefficient, and indicates the first precoding matrix to the terminal device through the TPMI.

In some embodiments, in the case where the 8-antenna port codebook has not been constructed from the 4-antenna port codebook or the 2-antenna port codebook, the terminal device can receive a second precoding matrix determined by the network device from the 4-antenna port codebook or the 2-antenna port codebook, and then the terminal device obtains the first precoding matrix corresponding to the 8-antenna port codebook through splicing based on the codebook coefficient and the second precoding matrix.

In some embodiments, the network device sends the TPMI to the terminal device, and the TPMI is configured to indicate an optimal precoding matrix determined by the network device based on channel estimation. In some embodiments, the optimal precoding matrix can be the first precoding matrix determined from the 8-antenna port codebook, or the optimal precoding matrix can be the second precoding matrix determined from the 4-antenna port codebook or the 2-antenna port codebook.

In some embodiments, in the case where the network device directly indicates the first precoding matrix through the TPMI, the terminal device can determine, based on the TPMI, the corresponding first precoding matrix for the uplink transmission from the 8-antenna port codebook corresponding to the uplink MIMO transmission. In some embodiments, a mapping relationship between the TPMIs and the precoding matrixes in the 8-antenna port codebook can be pre-set. The terminal device can determine, based on the received TPMI, the first precoding matrix required for the uplink transmission from the 8-antenna port codebook.

In some embodiments, in the case where the terminal device determines the first precoding matrix based on the codebook coefficient and the second precoding matrix, the terminal device can determine, based on the TPMI, the corresponding second precoding matrix for the uplink transmission from the 4-antenna port codebook or the 2-antenna port codebook corresponding to the uplink MIMO transmission. In some embodiments, a mapping relationship between the TPMIs and the precoding matrixes in the 4-antenna port codebook or in the 2-antenna port codebook can be pre-set. The terminal device can determine, based on the received TPMI, the second precoding matrix required for the uplink transmission from the 4-antenna port codebook or the 2-antenna port codebook.

In step S702, data pre-encoded based on the first precoding matrix and sent by the terminal device is received.

After obtaining the first precoding matrix, the terminal device can pre-encode the data to be transmitted based on the first precoding matrix and send the pre-encoded data to the network device. Correspondingly, the network device can receive the pre-encoded data. In some embodiments, the data to be transmitted can be PUSCH, which means that the terminal device pre-encodes the PUSCH through the first precoding matrix, and the network device can receive the pre-encoded PUSCH.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

Reference is made to FIG. 8, a flowchart of a method for determining a precoding matrix for uplink MIMO transmission according to embodiments of the present disclosure is provided. The method for determining the precoding matrix for the uplink MIMO transmission is performed by a network device. As shown in FIG. 8, the method can include but is not limited to the following steps.

In step S801, a codebook coefficient reported by a terminal device is received. The codebook coefficient includes a co-phase coefficient and/or a compensation factor for the antenna panel.

In some embodiments of the present disclosure, the 8-antenna port codebook can be obtained by splicing low dimensional 4-antenna port codebook and/or 2-antenna port codebook. In the process of splicing the 4-antenna port codebook and/or 2-antenna port codebook, it is necessary to determine the codebook coefficient, to splice candidate codewords in the 4-antenna port codebook and/or 2-antenna port codebook based on the codebook coefficient, to generate the 8-antenna port codebook.

It should be noted that the corresponding co-phase coefficients and/or the compensation factors between antenna panels corresponding to different antenna structures are different. In some embodiments, when a phase angle interval between antennas is 90°, the co-phase coefficient can be one of 1, −1, j, and −j, that is φ=+1, −1, +j, −j. In some embodiments, when a phase angle interval between antennas is 45°, the co-phase coefficient can be one of 1,

$$\frac{\sqrt{2}}{2} ( 1 + j ) , j , \frac{\sqrt{2}}{2} ( - 1 + j ) , - 1 , \frac{\sqrt{2}}{2} ( - 1 - j ) , - j , and \frac{\sqrt{2}}{2} ( 1 - j ) .$$

In some embodiments, the network device can receive a codebook coefficient index reported by the terminal device based on the antenna structure information. The codebook coefficient index is used to indicate the codebook coefficient, and the codebook coefficient is at least one coefficient in a candidate codebook coefficient set.

Different phase angle intervals between antennas correspond to different numbers of codebook coefficients included in the candidate codebook coefficient set. In some embodiments of the present disclosure, the number of bits occupied by the codebook coefficient index can be determined based on the phase angle interval between antennas indicated by the antenna structure information.

In some embodiments of the present disclosure, the correspondence between the codebook coefficient and the codebook coefficient index is constructed in advance. After receiving the codebook coefficient index, the network device can query the correspondence based on the codebook coefficient index, to determine the codebook coefficient reported by the terminal device.

In step S802, a first SRS sent by the terminal device based on an 8-antenna port codebook is received.

In some embodiments of the present disclosure, the network device can receive the first SRS for the 8-antenna port sent by the terminal device based on the 8-antenna port codebook.

In step S803, an optimal codeword is determined from the 8-antenna port codebook based on the codebook coefficient and the first SRS, to serve as a first precoding matrix.

In step S804, a TPMI is sent to the terminal device. The TPMI is used to indicate the first precoding matrix.

The network device can estimate the uplink channel based on the first SRS sent by the terminal device, and determine the optimal codewords for the uplink transmission from the 8-antenna port codebook, as the first precoding matrix. In some embodiments, the network device can indicate the TPMI corresponding to the first precoding matrix to the terminal device.

In some embodiments, the network device can further determine, based on uplink channel estimation, the corresponding SRS resources, transmission layers, MCS, etc. for the uplink transmission.

In some embodiments, the 8-antenna port codebook corresponds to a TPMI mapping table, and the TPMI mapping table includes a mapping relationship between candidate TPMIs and candidate codewords in the 8-antenna port codebook.

The network device can determine the TPMI of the first precoding matrix in the TPMI mapping table and send the TPMI to the terminal device.

In some embodiments, the 8-antenna port codebook corresponds to multiple TPMI mapping sub-tables, and different codebook coefficients correspond to different mapping sub-tables. Each mapping sub-table includes a mapping relationship between candidate TPMIs and candidate codewords in the 8-antenna port codebook.

The network device can determine, among the multiple TPMI mapping sub-tables, the first TPMI mapping sub-table corresponding to the received codebook coefficient, determine the TPMI of the first precoding matrix from the first TPMI mapping sub-table, and send the TPMI to the terminal device.

It should be noted that in the case where the 8-antenna port codebook corresponds to a TPMI mapping table, the network device needs to send the TPMI using a first bit number. The network device can indicate an index in the TPMI mapping table to the terminal device through ┌log₂^{card(S}^{_{8Tx}}⁾┐ bits (the first bit number), allowing the network device to send the TPMI to the terminal device through ┌log₂^{card(S}^{_{8Tx}}⁾┐ bits.

In the case where the 8-antenna port codebook corresponds to multiple TPMI mapping sub-tables, the network device needs to send the TPMI using a second number. The network device indicates an index in the TPMI mapping sub-table to the terminal device through ┌log₂^{max(card(S}^{_{8Tx}}^{,φ=x))}┐ bits (the second bit number), allowing the network device to send the TPMI to the terminal device through ┌log₂^{max(card(S}^{_{8Tx}}^{,φ=x))}┐ bits.

In some embodiments, the second bit number is less than or equal to the first bit number. In some embodiments, the network device can determine the number of codewords included in each TPMI mapping sub-table among the multiple TPMI mapping sub-tables, and determine a maximum number of codewords from the multiple TPMI mapping sub-tables. In some embodiments, the network device determines the second bit number based on the maximum number of codewords.

In step S805, data pre-encoded based on the first precoding matrix and sent by the terminal device is received.

For the specific explanations of step S805, reference can be made to the relevant contents recorded in the above embodiments, which will not be repeated here.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

Reference is made to FIG. 9, a flowchart of a method for determining a precoding matrix for uplink MIMO transmission according to embodiments of the present disclosure is provided. The method for determining the precoding matrix for the uplink MIMO transmission is performed by a network device. As shown in FIG. 9, the method can include but is not limited to the following steps.

In step S901, a second SRS sent by a terminal device based on a 4-antenna port codebook or a 2-antenna port codebook is received.

In step S902, an optimal codeword is determined from the 4-antenna port codebook or the 2-antenna port codebook based on the second SRS, to serve as a second precoding matrix.

In some embodiments, the network device can estimate the uplink channel based on the second SRS sent by the terminal device, and determine the optimal codeword for the uplink transmission from the 4-antenna port codebook or the 2-antenna port codebook, as the second precoding matrix. In some embodiments, the network device can indicate the TPMI corresponding to the second precoding matrix to the terminal device.

In some embodiments, the network device can further determine, based on uplink channel estimation, the corresponding SRS resources, transmission layers, MCS, etc. for the uplink transmission.

In step S903, a TPMI is sent to the terminal device. The TPMI is used to indicate the second precoding matrix, and the second precoding matrix is used to obtain the first precoding matrix.

The network device can send the TPMI to the terminal device. In some embodiments, the terminal device selects, based on the TPMI, the corresponding second precoding matrix from the set S_{2Tx} of codewords or the set S_{4Tx} of codewords, and splices the second precoding matrix based on the co-phase coefficient φ=x and a splicing formula for the 8-antenna port codeword, to generate the 8-antenna port codeword, thereby avoiding too large of the set of 8-port codewords and too large of the corresponding TPMI bit overhead.

In step S904, data pre-encoded based on the first precoding matrix and sent by the terminal device is received.

For the specific explanations of step S904, reference can be made to the relevant contents recorded in the above embodiments, which will not be repeated here.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

In the above embodiments of the present disclosure, the methods provided in the embodiments of the present disclosure are explained from the perspectives of the network device and the terminal device. In order to realize the functions in the methods provided in the above embodiments of the present disclosure, the network device and the first terminal device can include a hardware structure and a software module, and the above functions can be realized in the form of a hardware structure, a software module, or a hardware structure plus a software module. A certain function of the above functions can be performed in the form of a hardware structure, a software module, or a hardware structure plus a software module.

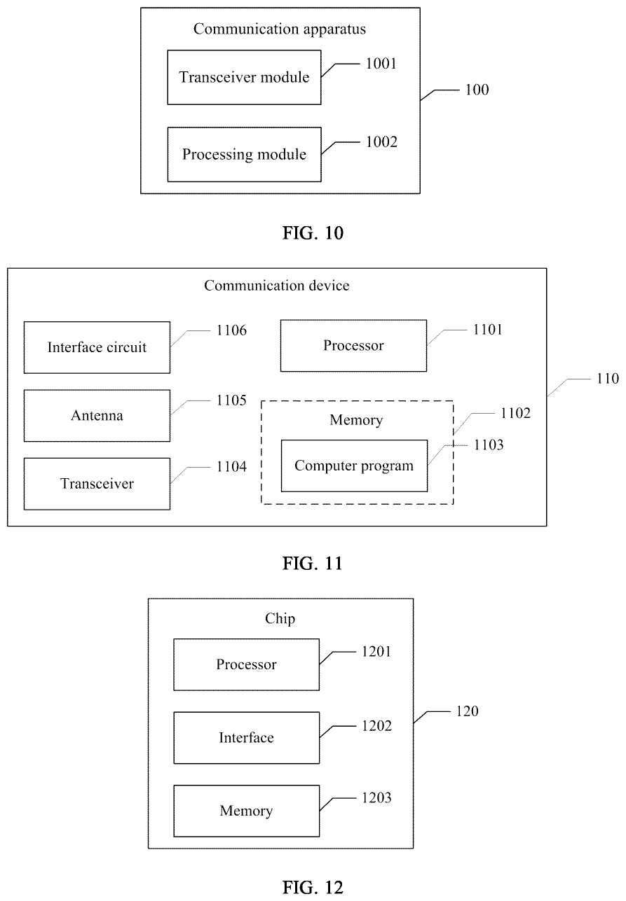

Reference is made to FIG. 10, a schematic diagram of a structure of a communication apparatus 100 according to embodiments of the present disclosure is provided. The communication apparatus 100 shown in FIG. 10 can include a transceiver module 1001 and a processing module 1002. The transceiver module 1001 can include a sending module and/or a receiving module, the sending module is used to realize the sending function, and the receiving module is used to realize the receiving function. The transceiver module 1001 can realize the sending function and/or the receiving function.

The communication apparatus 100 can be a terminal device, or an apparatus in a terminal device, or an apparatus that can be used with a terminal device. Alternatively, the communication apparatus 100 can be a network device, or an apparatus in a network device, or an apparatus that can be used with a network device.

The communication device 120 is a terminal device.

The processing module 1002 is configured to determine a codebook coefficient used for constructing an 8-antenna port codebook from a 4-antenna port codebook and/or a 2-antenna port codebook, and determine, based on the codebook coefficient, a first precoding matrix required for uplink transmission of the terminal device.

The transceiver module 1001 is configured to pre-encode data based on the first precoding matrix and sending the data to a network device.

In some embodiments, the transceiver module 1001 is further configured to report the codebook coefficient to the network device, with the codebook coefficient including a co-phase coefficient and/or a compensation factor for an antenna panel, send, based on the 8-antenna port codebook, a first sounding reference signal (SRS) to the network device, and receive a Transmit Precoding Matrix Indicator (TPMI) sent by the network device, with the TPMI being configured to indicate the first precoding matrix, and the first precoding being an optimal codeword determined from the 8-antenna port codebook based on the codebook coefficient and the first SRS.

In some embodiments, the processing module 1002 is further configured to determine the first precoding matrix based on the TPMI.

In some embodiments, the processing module 1002 is further configured to determine, in a TPMI mapping table corresponding to the 8-antenna port codebook, a first codeword indicated by the TPMI, to serve as the first precoding matrix, with the TPMI mapping table including a mapping relationship between candidate TPMIs and candidate codewords in the 8-antenna port codebook.

In some embodiments, the processing module 1002 is further configured to determine, among multiple TPMI mapping sub-tables corresponding to the 8-antenna port codebook, a first TPMI mapping sub-table that matches with the codebook coefficient, with different codebook coefficients being in correspondence with different mapping sub-tables, and the TPMI mapping sub-table including a mapping relationship between candidate TPMIs and candidate codewords in the 8-antenna port codebook, and to determine, from the first TPMI mapping sub-table, a second codeword indicated by the TPMI, to serve as the first precoding matrix.

In some embodiments, the transceiver module 1001 is further configured to send, based on the 4-antenna port codebook or the 2-antenna port codebook, a second SRS to the network device, and receive a TPMI sent by the network device, with the TPMI being configured to indicate a second precoding matrix, and the second precoding matrix being an optimal codeword determined from the 4-antenna port codebook or the 2-antenna port codebook based on the second SRS.

In some embodiments, the processing module 1002 is further configured to obtain the first precoding matrix based on the codebook coefficient and the second precoding matrix indicated by the TPMI.

In some embodiments, the transceiver module 1001 is further configured to report a codebook coefficient index to the network device based on antenna structure information, with the codebook coefficient index being configured to indicate the codebook coefficient, and the codebook coefficient being at least one coefficient in a candidate codebook coefficient set.

In some embodiments, the processing module 1002 is further configured to determine, based on the antenna structure information, a number of bits occupied by the codebook coefficient index, and report the codebook coefficient index to the network device based on the number of bits occupied.

In some embodiments, the processing module 1002 is further configured to determine the number of bits occupied by the codebook coefficient index based on a phase angle interval between antennas indicated by the antenna structure information.

The communication device 120 is a network device.

The transceiver module 1001 is configured to send a TPMI to a terminal device, with the TPMI being configured to determine a first precoding matrix in an 8-antenna port codebook, and the first precoding matrix being a precoding matrix required for uplink transmission of the terminal device, and to receive data pre-encoded based on the first precoding matrix and sent by the terminal device.

In some embodiments, the transceiver module 1001 is further configured to receive a codebook coefficient reported by the terminal device, with the codebook coefficient including a co-phase coefficient and/or a compensation factor for an antenna panel, and receive a first SRS sent by the terminal device based on the 8-antenna port codebook.

In some embodiments, the processing module 1002 is further configured to determine, based on the codebook coefficient and the first SRS, an optimal codeword from the 8-antenna port codebook, to serve as the first precoding matrix.

In some embodiments, the transceiver module 1001 is further configured to send the TPMI to the terminal device, with the TPMI being configured to indicate the first precoding matrix.

In some embodiments, the 8-antenna port codebook corresponds to a TPMI mapping table, and the TPMI mapping table includes a mapping relationship between candidate TPMIs and candidate codewords in the 8-antenna port codebook. The transceiver module 1001 is further configured to determine, in the TPMI mapping table, a TPMI of the first precoding matrix, and sending the TPMI to the terminal device.

In some embodiments, the 8-antenna port codebook corresponds to multiple TPMI mapping sub-tables, different codebook coefficients correspond to different mapping sub-tables, and the mapping sub-table includes a mapping relationship between candidate TPMIs and candidate codewords in the 8-antenna port codebook. The transceiver module 1001 is further configured to determine, among the multiple TPMI mapping sub-tables, a first TPMI mapping sub-table corresponding to the codebook coefficient, and determine, in the first TPMI mapping sub-table, a TPMI of the first precoding matrix, and sending the TPMI to the terminal device.

In some embodiments, the transceiver module 1001 is further configured to send the TPMI using a first bit number in case of the 8-antenna port codebook being in correspondence with a TPMI mapping table; or to send the TPMI using a second bit number in case of the 8-antenna port codebook being in correspondence with multiple TPMI mapping sub-tables. The second bit number is less than or equal to the first bit number.

In some embodiments, the processing module 1002 is further configured to determine a number of codewords included in each of the multiple TPMI mapping sub-tables, to determine a maximum number of codewords, and determine the second bit number based on the maximum number of codewords.

In some embodiments, the transceiver module 1001 is further configured to receive a second SRS sent by the terminal device based on a 4-antenna port codebook or a 2-antenna port codebook.

In some embodiments, the processing module 1002 is further configured to determine, based on the second SRS, an optimal codeword from the 4-antenna port codebook or the 2-antenna port codebook, to serve as a second precoding matrix.

In some embodiments, the transceiver module 1001 is further configured to send the TPMI to the terminal device, with the TPMI being configured to indicate the second precoding matrix, and the second precoding matrix is used for obtaining of the first precoding matrix.

In some embodiments, the transceiver module 1001 is further configured to receive a codebook coefficient index reported by the terminal device based on antenna structure information, with the codebook coefficient index being configured to indicate the codebook coefficient.

In some embodiments, the number of bits occupied by the codebook coefficient index is determined based on a phase angle interval between antennas indicated by the antenna structure information.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

Reference is made to FIG. 11, a schematic diagram of a structure of a communication device 110 according to embodiments of the present disclosure is provided. The communication device 110 can be a network device or a terminal device, and the communication device 110 can also be a chip, a chip system, or a processor that supports the network device to implement the above methods, or a chip, a chip system, or a processor that supports the terminal device to implement the above methods. The device can be used to implement the methods described in the above method embodiments, and the details can be referred to the descriptions in the above method embodiments.

The communication device 110 can include one or more processors 1101. The processor 1101 can be a general-purpose processor or a dedicated processor, etc. For example, the processor can be a baseband processor or a central processor. The baseband processor can be used to process communication protocols and communication data, and the central processor can be used to control the communication device (such as base stations, baseband chips, terminals, terminal chips, DU or CU, etc.), execute computer programs, and process computer program data.

In some embodiments, the communication device 110 can also include one or more memories 1102, and a computer program 1103 can be stored on the memory. The processor 1101 can execute the computer program 1103 to cause the communication device 110 to implement the methods described in the above embodiments. In some embodiments, the memory 1102 can also store data. The communication device 110 and the memory 1102 can be arranged separately or integrated together.

In some embodiments, the communication device 110 can also include a transceiver 1104 and an antenna 1105. The transceiver 1104 can be referred to as a transceiver unit, a transceiver machine, or a transceiver circuit, etc., and can be used to achieve a transceiving function. The transceiver 1104 can include a receiver and a transmitter. The receiver can be referred to as a receiver or a receiver circuit, etc., and is used to achieve a receiving function. The transmitter can be referred to as a transmitter or a transmitter circuit, etc., and is used to achieve a transmitting function.

In some embodiments, the communication device 110 can also include one or more interface circuits 1106. The interface circuit 1106 is used to receive code instructions and transmit the code instructions to the processor 1101. The processor 1101 executes the code instructions to cause the communication device 110 to implement the methods described in the above method embodiments.

The communication device 110 is a terminal device for implementing the functions of the terminal device in the above embodiments.

The communication device 110 is a network device for implementing the functions of the network device in the above embodiments.

In some embodiments, the processor 1101 can include a transceiver for achieving receiving and transmitting functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing codes/data, or the above-mentioned transceiver circuit, interface or interface circuit can be used for transmitting or transferring signals.

In some embodiments, the processor 1101 can store a computer program 1103, which runs on the processor 1101 and causes the communication device 110 to implement the methods described in the above embodiments. The computer program 1103 can be embedded in processor 1101, in which case the processor 1101 can be realized through hardware.

In some embodiments, the communication device 110 can include a circuit that can achieve receiving, transmitting, or communicating functions as described in the above method embodiments. The processor and the transceiver described in the present disclosure can be realized on the integrated circuit (IC), analog IC, radio frequency integrated circuit (RFIC), mixed signal IC, application specific integrated circuit (ASIC), printed circuit board (PCB), electronic device, and the like. The processor and the transceiver can also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device described in the above embodiments can be a network device or a terminal device, but the communication device described in the present disclosure is not limited to this, and the structure of the communication device may not be limited by FIG. 11. The communication device can be an independent device or can be part of a larger device. For example, the communication device can be at least one of:
(1) Independent integrated circuit ICs, or chips, or chip systems or subsystems.
(2) A set including one or more ICs, which can optionally also include storage components for storing data and computer programs.
(3) ASICs, for example, a modem.
(4) Modules that can be embedded in other devices.
(5) Receivers, terminals, intelligent terminals, cellular phones, wireless devices, handheld devices, mobile units, vehicle mounted devices, network side devices, cloud devices, artificial intelligence devices, etc.
(6) Other devices and so on.

For the case where the communication device can be a chip or a chip system, reference is made to FIG. 12, in which a schematic diagram of a structure of a chip according to embodiments of the present disclosure is shown. The chip shown in FIG. 12 includes a processor 1201 and an interface 1202. In some embodiments, the number of processors 1201 can be one or more, and the number of interfaces 1202 can be multiple.

The chip 120 is a terminal device for implementing the functions of the terminal device in the above embodiments.

The processor 1201 is configured to determine a codebook coefficient used for constructing an 8-antenna port codebook from a 4-antenna port codebook and/or a 2-antenna port codebook, and determine, based on the codebook coefficient, a first precoding matrix required for uplink transmission of the terminal device.

The interface 1202 is configured to pre-encode data based on the first precoding matrix and send the data to a network device.

In some embodiments, the interface 1202 is further configured to report the codebook coefficient to the network device, with the codebook coefficient including a co-phase coefficient and/or a compensation factor for an antenna panel, send, based on the 8-antenna port codebook, a first sounding reference signal (SRS) to the network device, and receive a Transmit Precoding Matrix Indicator (TPMI) sent by the network device, with the TPMI being configured to indicate the first precoding matrix, and the first precoding being an optimal codeword determined from the 8-antenna port codebook based on the codebook coefficient and the first SRS.

In some embodiments, the processor 1201 is further configured to determine the first precoding matrix based on the TPMI.

In some embodiments, the processor 1201 is further configured to determine, in a TPMI mapping table corresponding to the 8-antenna port codebook, a first codeword indicated by the TPMI, to serve as the first precoding matrix, with the TPMI mapping table including a mapping relationship between candidate TPMIs and candidate codewords in the 8-antenna port codebook.

In some embodiments, the processor 1201 is further configured to determine, among multiple TPMI mapping sub-tables corresponding to the 8-antenna port codebook, a first TPMI mapping sub-table that matches with the codebook coefficient, with different codebook coefficients being in correspondence with different mapping sub-tables, and the TPMI mapping sub-table including a mapping relationship between candidate TPMIs and candidate codewords in the 8-antenna port codebook, and to determine, from the first TPMI mapping sub-table, a second codeword indicated by the TPMI, to serve as the first precoding matrix.

In some embodiments, the interface 1202 is further configured to send, based on the 4-antenna port codebook or the 2-antenna port codebook, a second SRS to the network device, and receive a TPMI sent by the network device, with the TPMI being configured to indicate a second precoding matrix, and the second precoding matrix being an optimal codeword determined from the 4-antenna port codebook or the 2-antenna port codebook based on the second SRS.

In some embodiments, the processor 1201 is further configured to obtain the first precoding matrix based on the codebook coefficient and the second precoding matrix indicated by the TPMI.

In some embodiments, the interface 1202 is further configured to report a codebook coefficient index to the network device based on antenna structure information, with the codebook coefficient index being configured to indicate the codebook coefficient, and the codebook coefficient being at least one coefficient in a candidate codebook coefficient set.

In some embodiments, the processor 1201 is further configured to determine, based on the antenna structure information, a number of bits occupied by the codebook coefficient index, and report the codebook coefficient index to the network device based on the number of bits occupied.

In some embodiments, the processor 1201 is further configured to determine the number of bits occupied by the codebook coefficient index based on a phase angle interval between antennas indicated by the antenna structure information.

The chip 120 is a network device for implementing the functions of the network device in the above embodiments.

The interface 1202 is configured to send a TPMI to a terminal device, with the TPMI being configured to determine a first precoding matrix in an 8-antenna port codebook, and the first precoding matrix being a precoding matrix required for uplink transmission of the terminal device, and to receive data pre-encoded based on the first precoding matrix and sent by the terminal device.

In some embodiments, the interface 1202 is further configured to receive a codebook coefficient reported by the terminal device, with the codebook coefficient including a co-phase coefficient and/or a compensation factor for an antenna panel, and receive a first SRS sent by the terminal device based on the 8-antenna port codebook.

In some embodiments, the processing module 1002 is further configured to determine, based on the codebook coefficient and the first SRS, an optimal codeword from the 8-antenna port codebook, to serve as the first precoding matrix.

In some embodiments, the interface 1202 is further configured to send the TPMI to the terminal device, with the TPMI being configured to indicate the first precoding matrix.

In some embodiments, the 8-antenna port codebook corresponds to a TPMI mapping table, and the TPMI mapping table includes a mapping relationship between candidate TPMIs and candidate codewords in the 8-antenna port codebook. The interface 1202 is further configured to determine, in the TPMI mapping table, a TPMI of the first precoding matrix, and send the TPMI to the terminal device.

In some embodiments, the 8-antenna port codebook corresponds to multiple TPMI mapping sub-tables, different codebook coefficients correspond to different mapping sub-tables, and the mapping sub-table includes a mapping relationship between candidate TPMIs and candidate codewords in the 8-antenna port codebook. The interface 1202 is further configured to determine, among the multiple TPMI mapping sub-tables, a first TPMI mapping sub-table corresponding to the codebook coefficient, and determine, in the first TPMI mapping sub-table, a TPMI of the first precoding matrix, and send the TPMI to the terminal device.

In some embodiments, the interface 1202 is further configured to send the TPMI using a first bit number in case of the 8-antenna port codebook being in correspondence with a TPMI mapping table; or to send the TPMI using a second bit number in case of the 8-antenna port codebook being in correspondence with multiple TPMI mapping sub-tables. The second bit number is less than or equal to the first bit number.

In some embodiments, the processor 1201 is further configured to determine a number of codewords included in each of the multiple TPMI mapping sub-tables, to determine a maximum number of codewords, and determine the second bit number based on the maximum number of codewords.

In some embodiments, the interface 1202 is further configured to receive a second SRS sent by the terminal device based on a 4-antenna port codebook or a 2-antenna port codebook.

In some embodiments, the processor 1201 is further configured to determine, based on the second SRS, an optimal codeword from the 4-antenna port codebook or the 2-antenna port codebook, to serve as a second precoding matrix.

In some embodiments, the interface 1202 is further configured to send the TPMI to the terminal device, with the TPMI being configured to indicate the second precoding matrix, and the second precoding matrix is used for obtaining of the first precoding matrix.

In some embodiments, the interface 1202 is further configured to receive a codebook coefficient index reported by the terminal device based on antenna structure information, with the codebook coefficient index being configured to indicate the codebook coefficient.

In some embodiments, the number of bits occupied by the codebook coefficient index is determined based on a phase angle interval between antennas indicated by the antenna structure information.

The chip further includes a memory 1203, which is used for storing necessary computer programs and data.

According to embodiments of the present disclosure, the codebook coefficient used for constructing the 8-antenna port codebook from the 4-antenna port codebook and/or the 2-antenna port codebook is determined. Based on the codebook coefficient, the first precoding matrix required for the uplink transmission of the terminal device is determined. The data is pre-encoded based on the first precoding matrix and is sent to the network device. As a result, on the basis of the existing TPMI mechanism, the first precoding matrix that can support the uplink transmission based on 8-antenna ports in the MIMO system can be determined using the codebook coefficient, which can meet the requirements of uplink MIMO transmission enhancement.

Those skilled in the art can also understand that the various illustrative logical blocks and steps listed in the embodiments of the present disclosure can be achieved through electronic hardware, computer software, or a combination of both. Whether a function is achieved through hardware or software depends on the specific application and design requirements of the overall system. Those skilled in the art can use various methods to achieve the described functions for each specific application, but such achievement should not be understood as beyond the protection scope of the present disclosure.

Embodiments of the present disclosure also provide a communication system. The communication system includes a communication device serving as the terminal device and a communication device serving as the network device in the above embodiments shown in FIG. 8. Alternatively, the communication system includes a communication device serving as the terminal device and a communication device serving as the network device in the above embodiments shown in FIG. 9.

The present disclosure also provides a readable storage medium on which instructions are stored, and when the instructions are executed by a computer, the functions of any of the above method embodiments are achieved.

The present disclosure also provides a computer program product that achieves the functions of any of the above method embodiments when executed by a computer.

The above embodiments can be fully or partially implemented through software, hardware, firmware, or any combination thereof. When implemented using software, the embodiments can be fully or partially implemented in the form of a computer program product. The computer program product includes one or more computer programs. When the computer programs are loaded and executed on the computer, all or part of the processes or functions described in the embodiments of the present disclosure are generated. The computer can be a general-purpose computer, a dedicated computer, a computer network, or other programmable devices. The computer program can be stored in a computer-readable storage medium or transmitted from one computer-readable storage medium to another. For example, the computer program can be transmitted from a website site, a computer, a server, or a data center via wired (such as coaxial cable, optical fiber, digital subscriber line (DSL)) or wireless (such as infrared, wireless, microwave, etc.) communication, to transmit to another website, computer, server, or data center. The computer-readable storage medium can be any available medium that the computer can access, or a data storage device such as a server, a data center, etc. that integrates one or more available media. The available media can be magnetic media (such as floppy disks, hard drives, magnetic tapes), optical media (such as high-density digital video discs (DVDs)), or semiconductor media (such as solid state disks (SSDs)), etc.

Those of ordinary skill in the art can understand that the first, second, and other numerical numbers involved in the present disclosure are only for the convenience of description and differentiation, and are not used to limit the scope of embodiments of the present disclosure, but also indicate an order.

At least one in the present disclosure can also be described as one or more, where more can be two, three, four, or more, which is not limited in the present disclosure. In embodiments of the present disclosure, “first”, “second”, “third”, “A”, “B”, “C”, and “D” can be used to distinguish different technical features described, and the technical features described using “first”, “second”, “third”, “A”, “B”, “C”, and “D” are not distinguished from each other in an order or a magnitude.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the correspondence shown in certain rows may not be configured. For example, appropriate deformation adjustments can be made based on the above table, such as splitting, merging, etc. The names of the parameters shown in the titles of the above tables can also use other names that can be understood by the communication device, and the values or representations of the parameters can also use other values or representations that can be understood by the communication device. When implementing the above tables, other data structures can also be used, such as arrays, queues, containers, stacks, linear tables, pointers, linked lists, trees, graphs, structures, classes, heaps, hash tables, etc.

The term predefined in the present disclosure can be understood as defined, defined in advance, stored, stored in advance, negotiated in advance, configured in advance, solidified in advance, or fired in advance.

Those of ordinary skill in the art can realize that units and algorithm steps of each example described in embodiments of the present disclosure can be implemented in electronic hardware, or a combination of computer software and electronic hardware. Whether these functions are implemented in hardware or software depends on the specific application and design constraints of the technical solution. The skilled person can use different methods to achieve the described functions for each specific application, but such achievement should not be considered as beyond the scope of the present disclosure.

Those skilled in the art can clearly understand that for the convenience and conciseness of the description, the specific working processes of the system, device, and unit described above can refer to the corresponding processes in the above method embodiments, which will not be repeated here.

The above are only specific implementations of the present disclosure, but the protection scope of the present disclosure is not limited to this. Those changes or replacements that can be easily conceived by any skilled person familiar with the technical field within the scope of the present disclosure, should be within the protection scope of the present disclosure. Therefore, the protection scope of the present disclosure should be based on the protection scope of appended claims.

1. A method for determining a precoding matrix for uplink Multiple Input Multiple Output (MIMO) transmission, performed by a terminal device, the method comprising:
determining a codebook coefficient used for constructing an 8-antenna port codebook from at least one of a 4-antenna port codebook or a 2-antenna port codebook;
determining, based on the codebook coefficient, a first precoding matrix required for uplink transmission of the terminal device; and
pre-encoding data based on the first precoding matrix and sending the data pre-encoded to a network device.

2. The method according to claim 1, wherein determining, based on the codebook coefficient, the first precoding matrix required by the terminal device, comprises:
reporting the codebook coefficient to the network device, wherein the codebook coefficient comprises at least one of a co-phase coefficient or a compensation factor for an antenna panel;
sending, based on the 8-antenna port codebook, a first sounding reference signal (SRS) to the network device;
receiving a Transmit Precoding Matrix Indicator (TPMI) sent by the network device, wherein the TPMI is configured to indicate the first precoding matrix, and the first precoding matrix is an optimal codeword determined from the 8-antenna port codebook based on the codebook coefficient and the first SRS; and
determining the first precoding matrix based on the TPMI.

3. The method according to claim 2, wherein determining the first precoding matrix based on the TPMI, comprises:
determining, in a TPMI mapping table corresponding to the 8-antenna port codebook, a first codeword indicated by the TPMI, to serve as the first precoding matrix, wherein the TPMI mapping table comprises a mapping relationship between candidate TPMIs and candidate codewords in the 8-antenna port codebook.

4. The method according to claim 2, wherein determining the first precoding matrix based on the TPMI, comprises:
determining, among multiple TPMI mapping sub-tables corresponding to the 8-antenna port codebook, a first TPMI mapping sub-table that matches with the codebook coefficient, wherein different codebook coefficients correspond to different mapping sub-tables, and at least one of the multiple TPMI mapping sub-table comprises a mapping relationship between candidate TPMIs and candidate codewords in the 8-antenna port codebook; and
determining, from the first TPMI mapping sub-table, a second codeword indicated by the TPMI, to serve as the first precoding matrix.

5. The method according to claim 1, wherein determining, based on the codebook coefficient, the first precoding matrix required by the terminal device, comprises:
sending, based on the 4-antenna port codebook or the 2-antenna port codebook, a second SRS to the network device;
receiving a TPMI sent by the network device, wherein the TPMI is configured to indicate a second precoding matrix, and the second precoding matrix is an optimal codeword determined from the 4-antenna port codebook or the 2-antenna port codebook based on the second SRS; and
obtaining the first precoding matrix based on the codebook coefficient and the second precoding matrix indicated by the TPMI.

6. The method according to claim 2, wherein reporting the codebook coefficient to the network device, comprises:
reporting a codebook coefficient index to the network device based on antenna structure information, wherein the codebook coefficient index is configured to indicate the codebook coefficient, and the codebook coefficient is at least one coefficient in a candidate codebook coefficient set.

7. The method according to claim 6, further comprising:
determining, based on the antenna structure information, a number of bits occupied by the codebook coefficient index; and
reporting the codebook coefficient index to the network device based on the number of bits occupied.

8. The method according to claim 7, further comprising:
determining the number of bits occupied by the codebook coefficient index based on a phase angle interval between antennas indicated by the antenna structure information.

9. A method for determining a precoding matrix for uplink Multiple Input Multiple Output (MIMO) transmission, performed by a network device, the method comprising:
sending a Transmit Precoding Matrix Indicator (TPMI) to a terminal device, wherein the TPMI is configured to determine a first precoding matrix in an 8-antenna port codebook, and the first precoding matrix is a precoding matrix required for uplink transmission of the terminal device; and
receiving data pre-encoded based on the first precoding matrix and sent by the terminal device.

10. The method according to claim 9, wherein sending the TPMI to the terminal device, comprises:
receiving a codebook coefficient reported by the terminal device, wherein the codebook coefficient comprises at least one of a co-phase coefficient or a compensation factor for an antenna panel;
receiving a first sounding reference signal (SRS) sent by the terminal device based on the 8-antenna port codebook;
determining, based on the codebook coefficient and the first SRS, an optimal codeword from the 8-antenna port codebook, to serve as the first precoding matrix; and
sending the TPMI to the terminal device, wherein the TPMI is configured to indicate the first precoding matrix.

11. The method according to claim 10, further comprising:
determining, in a TPMI mapping table corresponding to the 8-antenna port codebook, a TPMI of the first precoding matrix, and sending the TPMI to the terminal device, wherein the TPMI mapping table comprises a mapping relationship between candidate TPMIs and candidate codewords in the 8-antenna port codebook.

12. The method according to claim 10, further comprising:
determining, among multiple TPMI mapping sub-tables corresponding to the 8-antenna port codebook, a first TPMI mapping sub-table corresponding to the codebook coefficient, wherein different codebook coefficients correspond to different mapping sub-tables, and at least one of the multiple TPMI mapping sub-tables comprises a mapping relationship between candidate TPMIs and candidate codewords in the 8-antenna port codebook; and
determining, in the first TPMI mapping sub-table, a TPMI of the first precoding matrix, and sending the TPMI to the terminal device.

13. The method according to claim 10, further comprising:
in case of the 8-antenna port codebook being in correspondence with a TPMI mapping table, sending the TPMI using a first bit number; and
in case of the 8-antenna port codebook being in correspondence with multiple TPMI mapping sub-tables, sending the TPMI using a second bit number, wherein the second bit number is less than or equal to the first bit number.

14. The method according to claim 13, wherein determining the second bit number comprises:
determining a number of codewords comprised in each of the multiple TPMI mapping sub-tables, to determine a maximum number of codewords; and
determining the second bit number based on the maximum number of codewords.

15. The method according to claim 9, wherein sending the TPMI to the terminal device, comprises:
receiving a second SRS sent by the terminal device based on a 4-antenna port codebook or a 2-antenna port codebook;
determining, based on the second SRS, an optimal codeword from the 4-antenna port codebook or the 2-antenna port codebook, to serve as a second precoding matrix; and
sending the TPMI to the terminal device, wherein the TPMI is configured to indicate the second precoding matrix, and the second precoding matrix is used for obtaining of the first precoding matrix.

16. The method according to claim 10, further comprising:
receiving a codebook coefficient index reported by the terminal device based on antenna structure information, wherein the codebook coefficient index is configured to indicate the codebook coefficient.

17. The method according to claim 16, wherein a number of bits occupied by the codebook coefficient index is determined based on a phase angle interval between antennas indicated by the antenna structure information.

18-19. (canceled)

20. A communication device, comprising a processor and a memory, wherein the memory stores a computer program, and the processor executes the computer program stored in the memory, to cause the method according to claim 1 to be performed.

21. A communication device, comprising a processor and a memory, wherein the memory stores a computer program, and the processor executes the computer program stored in the memory, to cause the method according to claim 9 to be performed.

22-23. (canceled)

24. A non-transitory computer-readable storage medium having instructions stored thereon, which when executed, cause the method according to claim 1 to be performed.

25. (canceled)
